(19) United States
(12) Patent Application Publication
(10) Pub. No.: US 2026/0181276 A1
(43) Pub. Date: Jun. 25, 2026

(54) SOLID-STATE IMAGING ELEMENT, IMAGING APPARATUS, AND IMAGING METHOD

(71) Applicant: OMNIVISION TECHNOLOGIES, INC., Santa Clara, CA (US)

(72) Inventor: Nagataka TANAKA, Kanagawa (JP)

(73) Assignee: OMNIVISION TECHNOLOGIES, INC., Santa Clara, CA (US)

(21) Appl. No.: 19/282,631

(22) Filed: Jul. 28, 2025

(30) Foreign Application Priority Data
Dec. 23, 2024 (JP) 2024-226579

(51) Int. Cl. H04N 25/59; H04N 23/67; H04N 25/709; H04N 25/77; H04N 25/78

(52) U.S. Cl. CPC H04N 25/59; H04N 23/672; H04N 25/77; H04N 25/78; H04N 25/709

(57) ABSTRACT

An overflow integration capacitor is shared by a pair of photodiodes. Overflow gates are provided between respective photodiodes and the overflow integration capacitor. Further, in the overflow gates, potential barriers are set lower than respective ones of transfer gates in charge accumulation periods of the photodiodes.

### CROSS REFERENCE TO RELATED APPLICATION

This application claims priority to Japanese Patent Application No. 2024-226579 filed on Dec. 23, 2024, which is incorporated herein by reference in its entirety including the specification, claims, drawings, and abstract.

### TECHNICAL FIELD

The present disclosure relates to a solid-state imaging element, an imaging apparatus, and an imaging method.

### BACKGROUND

As described in US2023/0156369 A, in a known imaging sensor circuit structure, called a shared pixel, a plurality of photodiodes (photo-electric conversion units) share a floating diffusion. For example, as described in Sunsoo Choi et al., “World smallest 200 Mp CMOS Image Sensor with 0.56 μm pixel equipped with novel Deep Trench Isolation structure for better sensitivity and higher CG”, 2023, International Image Sensor Workshop, May 22, 2023, and in US 2023/0156369 A, a group of four photodiodes (sub-pixels) share a floating diffusion. In addition, in the shared pixel structure, a potential barrier between adjacent sub-pixels is intentionally set to be lower than a potential barrier surrounding the sub-pixel group. With this configuration, when charges of a certain sub-pixel are saturated, the charges overflow to an adjacent sub-pixel. As a result, reduction of a dynamic range due to the shared pixel structure can be suppressed.

In US 2024/0259705 A, US 2020/0154066 A, and U.S. Pat. No. 8,184,191 B, in place of the overflow of the charges between sub-pixels, a lateral overflow integration capacitor (LOFIC) which forms an accepting structure for the saturated charges is incorporated in the image sensor circuit.

US2016/0240570A and US2023/0143387A disclose a dual pixel structure. In the dual pixel structure, a pair of photodiodes (sub-pixels) share a floating diffusion. For example, in a pixel array in which a plurality of dual pixels are two-dimensionally arranged, charges are separately read out from each sub-pixel for a predetermined row or column. Using the read-out charges, phase detection auto focus (PDAF) is enabled. In addition, by simultaneously reading out the charges of the pair of sub-pixels or adding the charges of the pair of sub-pixels, image production is performed. In other words, during the image production, the pair of sub-pixels are treated as an integrated pixel.

In the dual pixel structure, by providing the lateral overflow integration capacitor in each sub-pixel, the dynamic range can be improved with regard to both the image production and the phase detection auto focus. However, such a functional expansion may lead to an increase in the size of the pixel. In the present disclosure, a solid-state imaging element, an imaging apparatus, and an imaging method are disclosed which can improve the dynamic range of, in particular, the image production while suppressing the increase in the pixel size.

### SUMMARY

According to one aspect of the present disclosure, there is provided a solid-state imaging element comprising: a pair of photodiodes; a floating diffusion; a pair of transfer gates; an overflow integration capacitor; and a pair of overflow gates. The floating diffusion is shared by the pair of photodiodes. The transfer gates are provided respectively between the pair of photodiodes and the floating diffusion. The overflow integration capacitor is shared by the pair of photodiodes. The overflow gates are provided respectively between the pair of photodiodes and the overflow integration capacitor. Further, in the overflow gate, a potential barrier is set lower than that of the respective transfer gate during a charge accumulation period of the photodiode.

According to the above-described structure, the overflow integration capacitor is shared by the pair of photodiodes. Therefore, the increase in the pixel size can be suppressed in comparison with the case in which the overflow integration capacitor is provided individually for each photodiode.

According to another aspect of the present disclosure, there is provided an imaging apparatus comprising the solid-state imaging element described above. The imaging apparatus comprises a constant voltage source. The constant voltage source applies equal voltages to the pair of overflow gates.

According to the above-described structure, saturation charge amounts of the pair of photodiodes can be set equal to each other.

According to another aspect of the present disclosure, there is provided an imaging apparatus comprising the solid-state imaging element described above. The solid-state imaging element may comprise an overflow capacitor gate. The overflow capacitor gate is provided between the overflow integration capacitor and the floating diffusion. The imaging apparatus may comprise an A/D convertor. The A/D convertor reads out charges of the floating diffusion and converts the charges into a pixel value. The pair of transfer gates are simultaneously set to an ON state with respect to a pair of photodiodes designated as a pixel for image production, and transfer charges to the floating diffusion. Further, the overflow capacitor gate is set to an ON state with respect to the floating diffusion to which the charges are transferred from the pair of photodiodes. During a period in which the overflow capacitor gate is in the ON state, the A/D convertor reads out charges of the floating diffusion.

According to the above-described structure, when the capacity is expanded corresponding to the overflow integration capacitor, the charges are read out, so that the dynamic range during the image production is improved.

According to another aspect of the present disclosure, there is provided an imaging apparatus comprising the solid-state imaging element described above. The imaging apparatus may comprise an exposure time control unit. The exposure time control unit controls an exposure time corresponding to a charge accumulation period. In a pair of photodiodes designated as a pixel for phase detection auto focus, charges are transferred to the floating diffusion at timings different from each other. When at least one of the pair of photodiodes has reached the saturation charge amount, the exposure time control unit shortens the exposure time.

According to the above-described structure, phase detection auto focus which uses a pair of photodiodes before saturation (unsaturated) is enabled.

According to another aspect of the present disclosure, there is provided an imaging apparatus comprising the solid-state imaging element described above. The solid-state imaging element may comprise an overflow capacitor gate. The overflow capacitor gate is provided between the overflow integration capacitor and the floating diffusion. In addition, the imaging apparatus may comprise an A/D convertor. The A/D convertor reads out charges of the floating diffusion and converts the charges into a pixel value. The pair of transfer gates are set to an ON state at timings different from each other with respect to a pair of photodiodes designated as a pixel for phase detection auto focus, and transfer charges to the floating diffusion. When the photodiode for which the charges are transferred has reached the saturation charge amount, the overflow capacitor gate is set to an ON state with respect to the floating diffusion to which the charges are transferred from the photodiode. The A/D convertor calculates a pre-expansion pixel value before the overflow capacitor gate is set to the ON state and a post-expansion pixel value when the overflow capacitor gate is in the ON state.

According to the above-described structure, phase detection auto focus using the pre-expansion pixel value and the post-expansion pixel value is enabled.

In the above-described structure, the imaging apparatus may comprise an auto focus processing unit. The auto focus processing unit controls a lens position based on the phase detection auto focus. When one of the pair of photodiodes has reached the saturation charge amount, and the other of the pair of photodiodes is below the saturation charge amount, the auto focus processing unit sets a sum of the pre-expansion pixel value and the post-expansion pixel value of the one of the photodiodes as a pixel value of the one of the photodiodes.

According to the above-described structure, a dynamic range of the phase detection auto focus can be improved.

In the above-described structure, the imaging apparatus may comprise an exposure time control unit. The exposure time control unit controls an exposure time corresponding to a charge accumulation period. When both of the pair of photodiodes have reached the saturation charge amounts, the exposure time control unit shortens the exposure time.

When both of the pair of photodiodes have reached the saturation charge amounts, charges flow from the photodiodes to the overflow integration capacitor. By shortening the exposure time, a mixed flow of charges to the overflow integration capacitor when phase detection auto focus is performed can be suppressed.

According to another aspect of the present disclosure, there is provided an imaging method. In the imaging method, a solid-state imaging element is used. The solid-state imaging element comprises: a pair of photodiodes; a floating diffusion; a pair of transfer gates; an overflow integration capacitor; and a pair of overflow gates. The floating diffusion is shared by the pair of photodiodes. The transfer gates are provided respectively between the pair of photodiodes and the floating diffusion. The overflow integration capacitor is shared by the pair of photodiodes. The overflow gate is provided respectively between the pair of photodiodes and the overflow integration capacitor. A potential barrier of each of the pair of overflow gates is set to be lower than that of the respective transfer gate during a charge accumulation period of the photodiode.

In the above-described structure, voltages which are equal to each other may be applied to the pair of overflow gates.

In the above-described structure, the solid-state imaging element may comprise an overflow capacitor gate. The overflow capacitor gate is provided between the overflow integration capacitor and the floating diffusion. An imaging apparatus comprising the solid-state imaging element described above may comprise an overflow capacitor gate and an A/D convertor. The A/D convertor reads out charges of the floating diffusion and converts the charges to a pixel value. The pair of transfer gates are simultaneously set to an ON state with respect to a pair of photodiodes designated as a pixel for image production, and transfer charges to the floating diffusion. Further, the overflow capacitor gate is set to an ON state with respect to the floating diffusion to which the charges are transferred from the pair of photodiodes. During a period in which the overflow capacitor gate is in the ON state, the A/D convertor reads out charges of the floating diffusion.

In the above-described structure, an imaging apparatus comprising the solid-state imaging element may comprise an exposure time control unit. The exposure time control unit controls an exposure time corresponding to a charge accumulation period. Charges are transferred from a pair of photodiodes designated as a pixel for phase detection auto focus to the floating diffusion at timings different from each other. When at least one of the pair of photodiodes has reached a saturation charge amount, the exposure time control unit shortens the exposure time.

In the above-described structure, the solid-state imaging element may comprise an overflow capacitor gate. The overflow capacitor gate is provided between the overflow integration capacitor and the floating diffusion. In addition, an imaging apparatus comprising the solid-state imaging element described above may comprise an overflow capacitor gate and an A/D convertor. The A/D convertor reads out charges of the floating diffusion and converts the charges into a pixel value. The pair of transfer gates are set to an ON state at timings different from each other with respect to a pair of photodiodes designated as a pixel for phase detection auto focus, and transfer charge to the floating diffusion. When a photodiode for which the charges are to be transferred has reached the saturation charge amount, the overflow capacitor gate is set to an ON state with respect to the floating diffusion to which the charges are transferred from the photodiode. The A/D convertor calculates a pre-expansion pixel value before the overflow capacitor gate is set to the ON state and a post-expansion pixel value when the overflow capacitor gate is in the ON state.

In the above-described structure, the imaging apparatus may comprise an auto focus processing unit. The auto focus processing unit controls a lens position based on the phase detection auto focus. When one of the pair of photodiodes has reached the saturation charge amount and the other of the pair of photodiodes is below the saturation charge amount, the auto focus processing unit sets a sum of the pre-expansion pixel value and the post-expansion pixel value of the one of the photodiodes as a pixel value of the one of the photodiodes.

In the above-described structure, the imaging apparatus may comprise an exposure time control unit. The exposure time control unit controls an exposure time corresponding to a charge accumulation period. When both of the pair of photodiodes have reached the saturation charge amounts, the exposure time control unit shortens the exposure time.

According to the imaging apparatus and the imaging method according to an aspect of the present disclosure, a dynamic range of in particular image production can be improved while an increase in the pixel size is suppressed.

### BRIEF DESCRIPTION OF DRAWINGS

Embodiment(s) of the present disclosure will be described based on the following figures, wherein:

FIG. 1 is a diagram exemplifying an imaging apparatus according to an embodiment of the present disclosure;

FIG. 2 is a diagram exemplifying a hardware structure of a control apparatus;

FIG. 3 is a diagram exemplifying a circuit surface structure of a solid-state imaging apparatus, at a side opposite from a light receiving surface;

FIG. 4 is a diagram exemplifying a circuit structure of the solid-state imaging apparatus;

FIG. 5 is a diagram for explaining a flow of overflown charges;

FIG. 6 is a diagram for explaining potential barriers of a transfer gate TX1 and an overflow gate OFG1;

FIG. 7 is a diagram for explaining potential barriers of a transfer gate TX2 and an overflow gate OFG2;

FIG. 8 is a diagram exemplifying a timing chart during image production;

FIG. 9 is a diagram exemplifying a timing chart during phase detection auto focus (pre-saturation transfer type);

FIG. 10 is a diagram for explaining a dynamic range during image production and phase detection auto focus (pre-saturation transfer) by an imaging apparatus according to an embodiment of the present disclosure;

FIG. 11 is a diagram exemplifying processing of a pixel value for phase detection auto focus using an overflow integration capacitor;

FIG. 12 is a diagram exemplifying a timing chart (only one of pixels being saturated) of phase detection auto focus using the overflow integration capacitor;

FIG. 13 is a diagram exemplifying a timing chart (both pixels being saturated) of phase detection auto focus using the overflow integration capacitor;

FIG. 14 is a diagram for explaining a dynamic range of phase detection auto focus using the overflow integration capacitor; and

FIG. 15 is a circuit diagram exemplifying a structure of a shared pixel using the solid-state imaging element according to an embodiment of the present disclosure.

### DESCRIPTION OF EMBODIMENTS

An imaging apparatus and an imaging method according to an embodiment of the present disclosure will now be described with reference to the drawings. Shapes, materials, numbers, and numerical values described below are merely exemplary for the purpose of explanation. The shapes or the like may be suitably changed in accordance with the specification of the imaging apparatus. Further, in the following, similar elements similar over multiple drawings will be assigned the same reference numerals.

### 1. Structure of Imaging Apparatus

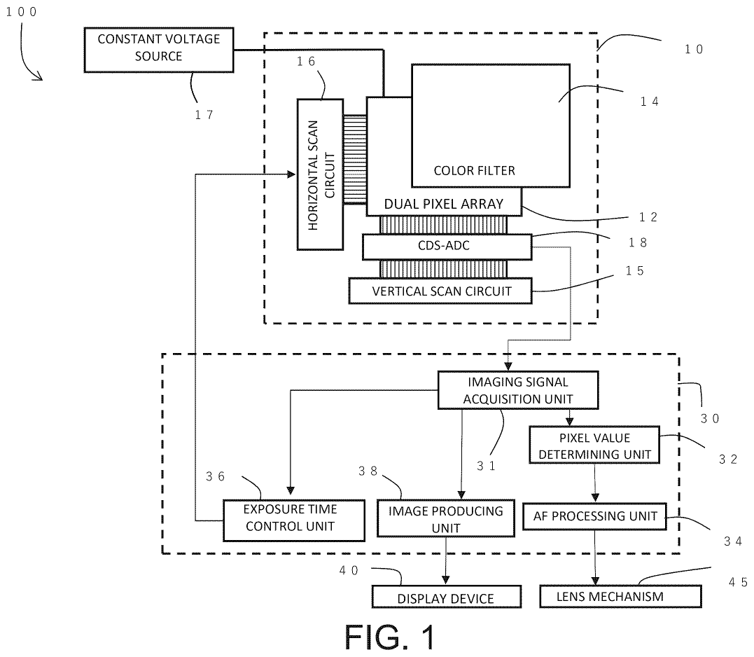

With reference to FIG. 1, an imaging apparatus 100 according to the present embodiment comprises a solid-state imaging apparatus 10, a control device 30, a display device 40, and a lens mechanism 45. In the solid-state imaging apparatus 10, photoelectric conversion and A/D conversion are performed. That is, charges photoelectrically converted by a dual pixel array 12 are converted to a pixel value, which is a digital value, by a CDS-ADC circuit 18. A detailed structure will be described later.

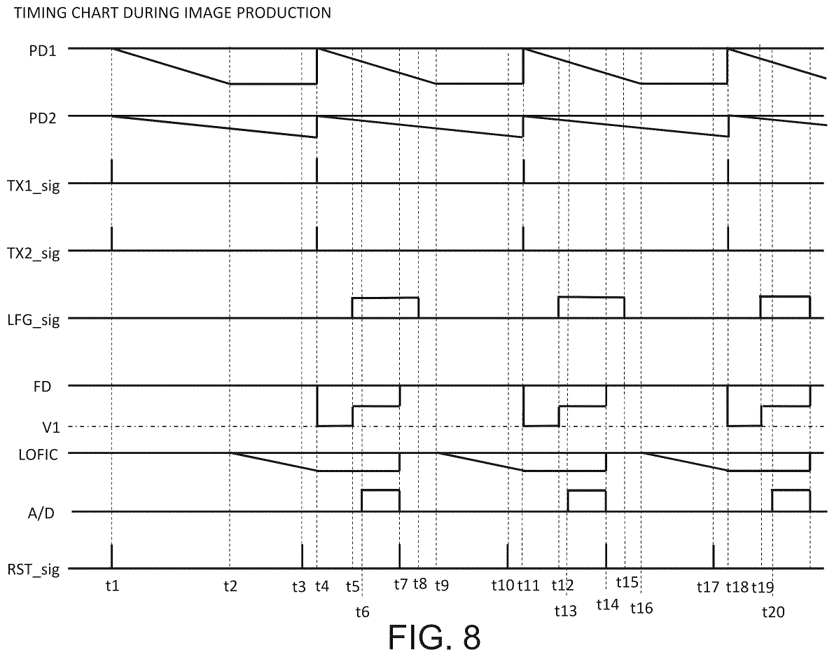

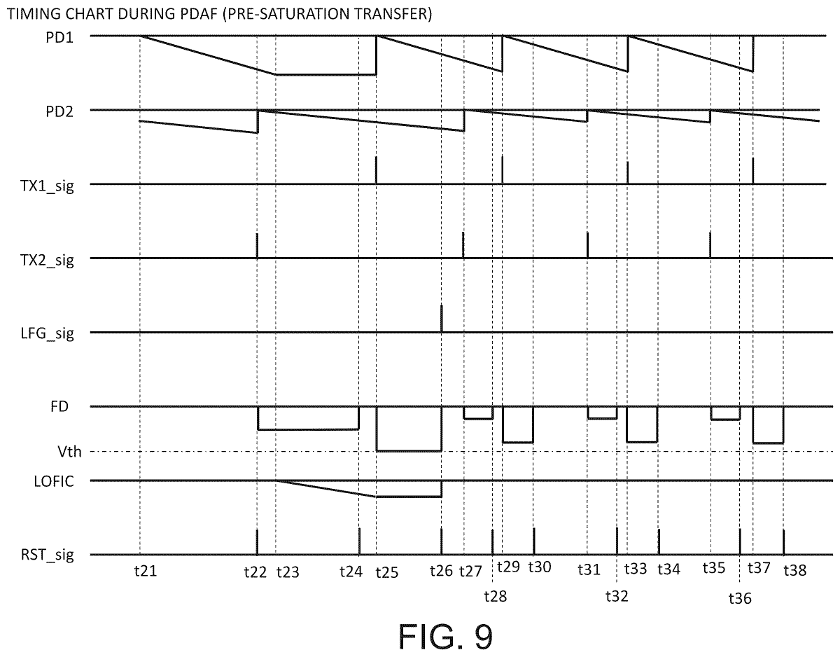

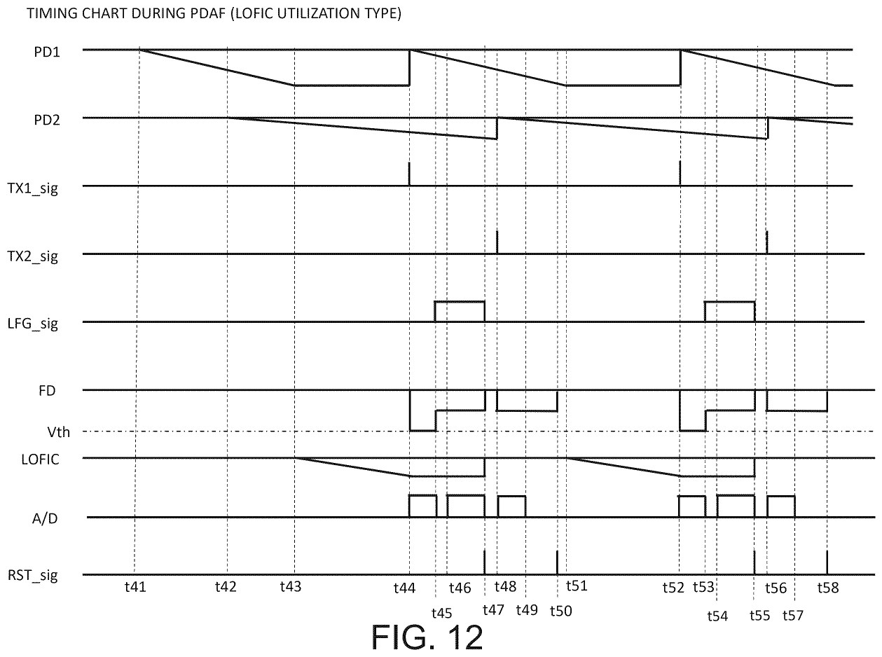

Based on a pixel value acquired by a timing chart exemplified in FIG. 8, the control device 30 performs image production. In addition, based on a pixel value acquired by a timing chart exemplified in FIG. 9 or FIG. 12, the control device 30 performs phase detection auto focus. A detailed structure will be described later.

The display device 40 displays an image produced by an image producing unit 38. The lens mechanism 45 adjusts a position of a lens placed in front of (that is, on an upstream side along a direction of incidence) a light receiving surface of the dual pixel array 12.

### 2. Structure of Solid-State Imaging Apparatus

The solid-state imaging apparatus 10 comprises the dual pixel array 12, a color filter array 14, a vertical scan circuit 15, a horizontal scan circuit 16, and the CDS-ADC circuit 18.

The color filter array 14 is placed on the light receiving surface of the dual pixel array 12. For example, in the color filter array 14, color filters of red (R), green (Gr, Gb), and blue (B) are two-dimensionally arranged. The two-dimensional arrangement is, for example, the Bayer arrangement.

The horizontal scan circuit 16 is a circuit which selects a reading-out row of the dual pixel array 12. The CDS-ADC circuit 18 retains and performs analog-to-digital conversion (A/D conversion) of a signal (voltage value) of each pixel of the dual pixel array 12. As the mechanisms for retaining and A/D converting the signal by the CDS-ADC circuit 18 are known, the mechanisms will not be described herein.

Of the CDS-ADC circuit 18, the ADC circuit portion is also called an A/D converter. The A/D converter reads out charges of a floating diffusion and converts the charges into a pixel value. The digital value after the conversion is called a pixel value. For example, the pixel value assumes a value from a minimum value of 0 to a maximum value of 255. The vertical scan circuit 15 instructs the CDS-ADC circuit 18 (A/D converter) as to which column of the dual pixel array 12 is to be read out.

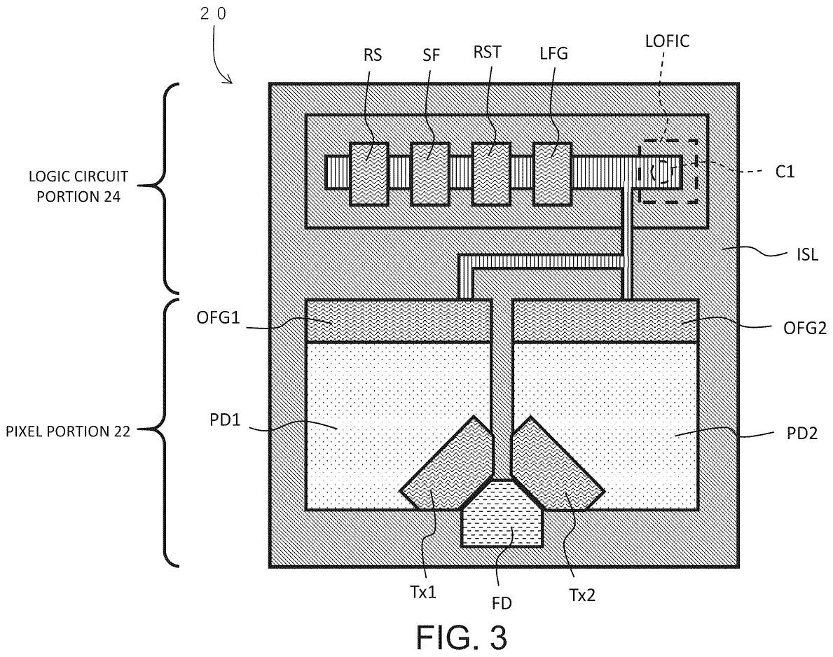

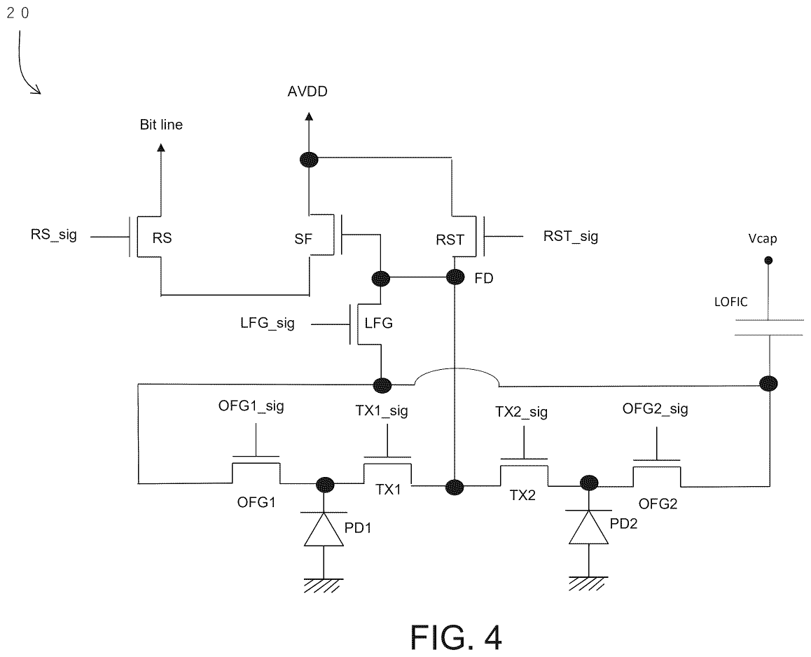

FIGS. 3 and 4 exemplify a solid-state imaging element 20 which is an element circuit of the dual pixel array 12. The solid-state imaging element 20 is also called a dual pixel. In the dual pixel array 12, the solid-state imaging elements 20 are two-dimensionally arranged along a row direction and a column direction.

The solid-state imaging element 20 is, for example, a backside illumination CMOS image sensor. FIG. 3 exemplifies a circuit surface at an opposite side from the light receiving surface. FIG. 4 exemplifies a circuit of the solid-state imaging element 20.

The solid-state imaging element 20 has a dual pixel structure. That is, in the solid-state imaging element 20, a pair of photodiodes PD1 and PD2 are paired. That is, the pair of photodiodes PD1 and PD2 share one floating diffusion FD. As will be described later, when charges of the pair of photodiodes PD1 and PD2 are used for image production, the pair of photodiodes PD1 and PD2 are treated as an integral pixel. On the other hand, when the charges of the pair of photodiodes PD1 and PD2 are used for phase detection auto focus, the pair of photodiodes PD1 and PD2 are treated as sub-pixels that are independent from each other.

Between the photodiode PD1 and the floating diffusion FD, a transfer gate TX1 is provided. Similarly, between the photodiode PD2 and the floating diffusion FD, a transfer gate TX2 is provided.

The pair of photodiodes PD1 and PD2 share one capacitor. The capacitor is called an overflow integration capacitor. The overflow integration capacitor is, for example, a lateral overflow integration capacitor (LOFIC). Because the overflow integration capacitor LOFIC is shared by the pair of photodiodes PD1 and PD2, the overflow integration capacitor LOFIC is also called a shared LOFIC.

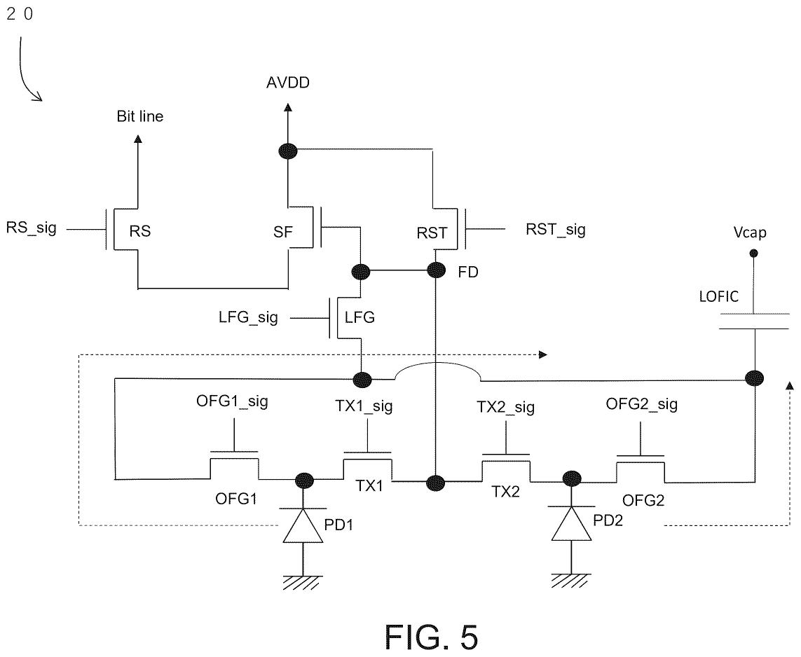

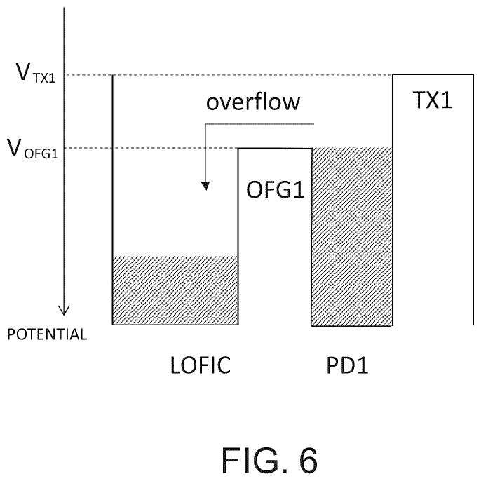

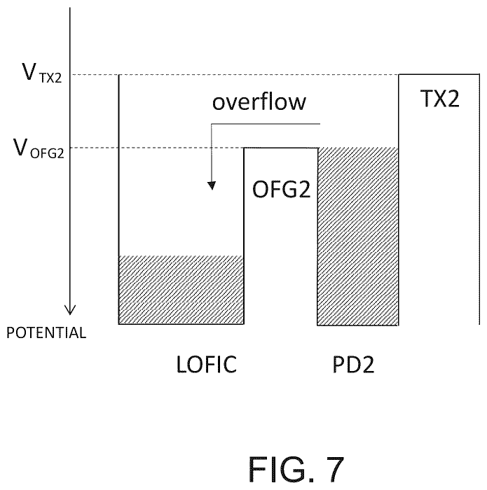

The pair of photodiodes PD1 and PD2 are in electrical conduction with the overflow integration capacitor LOFIC. Further, overflow gates OFG1 and OFG2 are provided on this conductive paths (wirings). As exemplified in FIG. 5, charges of the photodiodes PD1 and PD2 exceeding potential barriers V_{OFG} (refer to FIGS. 6 and 7) of the overflow gates OFG1 and OFG2 are both accumulated in the overflow integration capacitor LOFIC.

FIG. 3 exemplifies the circuit surface of the solid-state imaging element 20. The solid-state imaging element 20 comprises a pixel portion 22 and a logic circuit portion 24. The overflow integration capacitor LOFIC is placed in the logic circuit portion 24. For example, a contact C1 is formed on a wiring connecting the overflow gates OFG1 and OFG2 and an overflow capacitor gate LFG. The contact C1 extends in a depth direction (layering direction), which is perpendicular to the circuit surface. To the contact C1, the overflow integration capacitor LOFIC is connected.

In the solid-state imaging element 20 according to the present embodiment, the number of the overflow integration capacitor LOFIC provided in the logic circuit portion 24 may be one. Therefore, enlargement of a placement space can be suppressed, in comparison to a case where, for example, a pair of the overflow integration capacitors LOFIC are provided.

Further, a number of nodes can be reduced in the solid-state imaging element 20 according to the present embodiment, in comparison to a case where a pair of the overflow integration capacitors LOFIC are provided. In FIG. 4, the nodes are shown with black circles. In general, each of the nodes is formed from an N+ region. It is known that a dark current tends to be easily generated in the N+ region. By suppressing the increase in the number of nodes, the increase of the dark current can be suppressed.

With reference to FIGS. 3 and 4, on the circuit, the overflow gate OFG1 is provided between the overflow integration capacitor LOFIC and the photodiode PD1. Similarly, on the circuit, the overflow gate OFG2 is provided between the overflow integration capacitor LOFIC and the photodiode PD2.

Further, on the circuit, the overflow capacitor gate LFG is provided between the overflow integration capacitor LOFIC and the floating diffusion FD. On a path from the floating diffusion FD to a bit line, a reset gate RST, a source follower SF, and a row selection gate RS are provided.

On the circuit structure, charges accumulated in the photodiodes PD1 and PD2 can be transferred to the floating diffusion FD. In addition, charges overflown from the photodiodes PD1 and PD2 can be accumulated in the overflow integration capacitor LOFIC. FIG. 6 shows a potential distribution of the photodiode PD1, the transfer gate TX1, and the overflow gate OFG1 during a charge accumulation period (that is, an exposure time). When light is incident on the photodiode PD1, charges are accumulated in the photodiode PD1 through photoelectric conversion. During this accumulation period, a potential barrier V_{OFG1} of the overflow gate OFG1 is set at a value lower than a potential barrier V_{TX1} of the transfer gate TX1 (V_{OFG1}<V_{TX1}).

FIG. 7 exemplifies a potential distribution of the photodiode PD2, the transfer gate TX2, and the overflow gate OFG2 during the charge accumulation period (that is, the exposure time). Similar to FIG. 6, when light is incident on the photodiode PD2, charges are accumulated in the photodiode PD2 through photoelectric conversion. During this accumulation period, a potential barrier V_{OFG2} of the overflow gate OFG2 is set at a value lower than a potential barrier V_{TX2} of the transfer gate TX2 (V_{OFG2}<V_{TX2}). In addition, for example, the potential barriers V_{TX1} and V_{TX2} are equal to each other (V_{TX1}=V_{TX2}). Further, the overflow potentials V_{OFG1} and V_{OFG2} are equal to each other (V_{OFG1}=V_{OFG2}).

That is, when the potentials of the photodiodes PD1 and PD2 reach the overflow potentials V_{OFG1} and V_{OFG2} during the accumulation period of the charges, the charges move over the overflow gates OFG1 and OFG2, and are accumulated in the overflow integration capacitor LOFIC. Because of this, saturation charge amounts of the photodiodes PD1 and PD2 are equal to the overflow potentials V_{OFG1} and V_{OFG2}. By setting the overflow potentials V_{OFG1} and V_{OFG2} to be equal to each other (V_{OFG1}=V_{OFG2}), the photodiodes PD1 and PD2 may be set to have saturation charge amounts equal to each other. For example, when the imaging apparatus 100 is in an ON state, overflow potentials V_{OFG1} and V_{OFG2} are applied at all times from a constant voltage source 17 (refer to FIG. 1) to the overflow gates OFG1 and OFG2.

### 3. Structure of Control Device

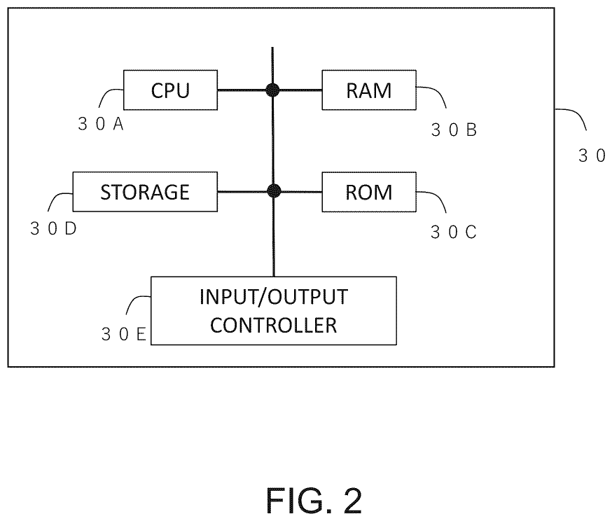

The control device 30 is formed from, for example, a computer as exemplified in FIG. 2. That is, the control device 30 comprises a CPU 30A, a RAM 30B, a ROM 30C, a storage 30D, and an input/output controller 30E.

The CPU 30A is a central processing unit, and is also called a processor. The RAM 30B is a volatile or nonvolatile storage device which temporarily stores data during operation. The ROM 30C is a storage device from which data can be read out. The storage 30D is a storage device to and from which data can be written and read out. The storage 30D is formed from, for example, an HDD (Hard Disk Drive) or an SSD (Solid State Drive).

By the CPU 30A executing a program stored in the storage 30D or the ROM 30C, functional units as exemplified in FIG. 1 are formed in the control device 30. That is, the control device 30 comprises an imaging signal acquisition unit 31, a pixel value determining unit 32, an auto focus processing unit 34, an exposure time control unit 36, and the image producing unit 38. Details of these functional units will be described later.

FIG. 8 exemplifies an operation of the solid-state imaging apparatus 10 for acquiring a pixel value for image production. The pixel value acquired through this operation is sent via the imaging signal acquisition unit 31 to the image producing unit 38. The image producing unit 38 produces an image based on the acquired pixel value. The produced image is displayed on the display device 40. Details of the timing chart of FIG. 8 will be described later.

FIG. 9 exemplifies an operation of the solid-state imaging apparatus 10 for acquiring a pixel value for phase detection auto focus. The pixel value acquired through this operation is sent via the imaging signal acquisition unit 31 to the pixel value determining unit 32 and the auto focus processing unit 34. Because the phase detection auto focus technique is known, description thereof will not be given herein. Further, details of the timing chart of FIG. 9 will be described later.

For example, in order to perform the phase detection auto focus, the solid-state imaging elements 20 of the dual pixel array 12 are designated in units of rows or in units of columns. Based on the pixel value of each of the photodiodes PD1 and PD2 acquired from the respective solid-state imaging element 20, it is calculated to which of a focal point, a front focus, and a rear focus the focus position with respect to a subject corresponds. Further, based on a result of the calculation, an amount of movement of the lens is determined. The determined amount of movement is sent to the lens mechanism 45.

### 4. Operation During Image Production

FIG. 8 exemplifies a timing chart of the solid-state imaging apparatus 10 for acquiring the pixel value for image production. In FIGS. 8, 9, 12, and 13, because the overflow gates OFG1 and OFG2 are set to constant voltages, the overflow gates OFG1 and OFG2 will not be shown in the figures.

At times t1 to t3, charges are accumulated in the photodiodes PD1 and PD2. Here, in many cases, angles of incidence with respect to the photodiode PD1 and the photodiode PD2 differ from each other. Therefore, a form of accumulation of the charges differs between the photodiode PD1 and the photodiode PD2. In FIGS. 8, 9, and 12, an example case is shown in which a larger amount of light is incident on the photodiode PD1 than on the photodiode PD2.

With reference to FIG. 8, when charges of the photodiode PD1 are saturated (when the saturation charge amount is reached) at a time t2, charges overflown from the photodiode PD1 are accumulated in the overflow integration capacitor LOFIC.

When the reset gate RST is set to the ON state (open), and the voltage of the floating diffusion FD is set at a reference voltage at the time t3, the transfer gates TX1 and TX2 are simultaneously set to the ON state (open) at a time t4. The charges accumulated in the photodiodes PD1 and PD2 are transferred to the floating diffusion FD. In other words, at the floating diffusion FD, the charges of the photodiodes PD1 and PD2 are added together.

At a time t5, the overflow capacitor gate LFG is set to an ON state (open state). For example, the ON state of the overflow capacitor gate LFG is continued until a time t8.

With the state of the overflow capacitor gate LFG being the ON state (open), the overflow integration capacitor LOFIC and the floating diffusion are set at equal potentials. Because the overflow integration capacitor LOFIC has a larger capacity than the floating diffusion, the potential of the floating diffusion FD is reduced (dragged down) to the potential of the overflow integration capacitor LOFIC. That is, the capacity for accepting the charges is temporarily expanded by the overflow integration capacitor LOFIC.

Therefore, even when light of a high luminance which would saturate the photodiodes PD1 and PD2 is incident, the pixel value after the expansion of the capacity does not saturate. In other words, with the overflow integration capacitor LOFIC, a dynamic range during the image production is expanded. The dynamic range of the image production refers to a range from a minimum value of a signal intensity in which a so-called black crushing phenomenon occurs to a maximum value of the signal intensity in which a so-called whiteout phenomenon occurs.

The CDS-ADC circuit 18 (refer to FIG. 1) performs the A/D conversion in a linked manner with the overflow capacitor gate LFG. For example, the A/D conversion is performed from a time t6 which is delayed by a predetermined time from a time of switching (time t5) from the OFF state (close) to the ON state (open) of the overflow capacitor gate LFG. With regard to a period of the A/D conversion, a period from the time t6 to, for example, a time t7 at which the reset gate is set to the ON state (open) is the A/D conversion period. During the A/D conversion period, the CDS-ADC circuit 18 reads out the charges of the floating diffusion FD. Subsequently, the above-described processes are repeated.

### 5. Phase Detection Auto Focus of Pre-Saturation Transfer Type

FIG. 9 exemplifies a timing chart for acquiring a pixel value for phase detection auto focus. In FIG. 9, a timing chart is shown for a case when the phase detection auto focus of a pre-saturation transfer type is performed. That is, in FIG. 9, both the photodiodes PD1 and PD2 are controlled so that the accumulated charges are less than the saturation charge amounts.

Further, in the phase detection auto focus of the pre-saturation transfer type, when at least one of the photodiodes PD1 and PD2 has reached the saturation charge amount, the exposure time control unit 36 (refer to FIG. 1) shortens the exposure time.

In the phase detection auto focus, solid-state imaging elements 20 (refer to FIG. 3) of a predetermined row or a predetermined column are designated in the dual pixel array 12 (refer to FIG. 1). Charges of the solid-state imaging elements 20 which are not designated are read out according to the process of FIG. 8, and are thus used for image production.

In the phase detection autofocus, charges of the photodiodes PD1 and PD2 are independently acquired. That is, the transfer gates TX1 and TX2 are set to the ON state (open) at different timings. For example, in FIG. 9, the transfer gate TX1 is set to the ON state (open) at times t25, t29, t33, and t37. Periods in which the charges of the photodiode PD1 are transferred to the floating diffusion FD and are read out are periods of t25 to t26, t29 to t30, t33 to t34, and t37 to t38.

On the other hand, the transfer gate TX2 is set to the ON state (open) at times t22, t27, t31, and t35. In addition, periods in which the charges of the photodiode PD2 are transferred to the floating diffusion FD and are read out are periods of t22 to t24, t27 to t28, t31 to t32, and t35 to t36.

At a time t23, the accumulated charges of the photodiode PD1 are saturated. The saturated charges flow into the overflow integration capacitor LOFIC. Because the accumulated charges of the photodiode PD1 are saturated, if the charges are transferred from the photodiode PD1 to the floating diffusion FD at the time t25, the potential of the floating diffusion FD is set at the saturation charge amount Vth.

When the charges of the saturation charge amount Vth are A/D converted by the CDS-ADC circuit 18, the pixel value assumes the maximum value of 255. When the pixel value determining unit 32 (refer to FIG. 1) determines that the pixel value is the maximum value, the pixel value determining unit 32 sends a shortening command of exposure time to the exposure time control unit 36. The exposure time control unit 36 adjusts a timing chart with respect to the dual pixel array 12. For example, the exposure time control unit 36 shortens the charge accumulation periods from the setting ON (open) of the reset gate RST to the setting ON (open) of the transfer gates TX1 and TX2; that is, the exposure time.

After the exposure time is adjusted, with reference to times t27 to T28 and times t29 to t30, both of the accumulated charges of the photodiodes PD1 and PD2 are less than the saturation charge amount Vth. When the accumulated charges of the photodiodes PD1 and PD2 are respectively A/D converted, the pixel value determining unit 32 transmits the resulting pixel values to the auto focus processing unit 34.

The auto focus processing unit 34 adjusts the lens position based on the phase detection auto focus. The auto focus processing unit 34 calculates the phase detection auto focus based on a pair of pixel values (more specifically, a pair of pixel values of an arbitrary row or an arbitrary column of the dual pixel array 12). As a result of the calculation, an amount of movement of the lens is determined. The determined amount of movement of the lens is sent to the lens mechanism 45.

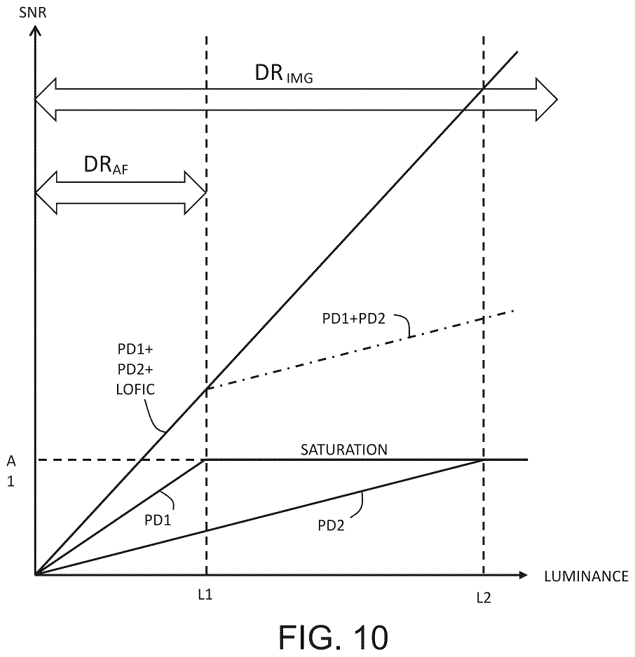

FIG. 10 exemplifies a dynamic range DR_{IMG} during image production and a dynamic range DR_{AF} during the phase detection auto focus. The dynamic range DR_{IMG} is determined based on the pixel value acquired based on the timing chart exemplified in FIG. 8, and the dynamic range DR_{AF} is determined based on the pixel value acquired based on the timing chart exemplified in FIG. 9.

In a graph of FIG. 10, the horizontal axis shows luminance, and the vertical axis shows an S/N ratio. As described above, due to the difference in the angles of incidence with respect to the photodiodes PD1 and PD2, the form of accumulation of the charges differ between the photodiodes PD1 and PD2. In FIG. 10, a larger amount of light is incident on the photodiode PD1 than on the photodiode PD2.

With reference to FIG. 10, a luminance L1 at which the saturation charge amount of one of the photodiodes PD1 and PD2 is reached is an upper limit of the dynamic range DR_{AF} of the phase detection auto focus. On the other hand, with regard to the dynamic range DR_{IMG} of the image production, the dynamic range is expanded to the maximum capacity of the overflow integration capacitor LOFIC, even when either of the accumulated charges of the photodiode PD1 and the photodiode PD2 is saturated. In this manner, in the imaging apparatus of the present embodiment, the dynamic range can be expanded in particular during image production.

### 6. Phase Detection Auto Focus Utilizing Overflow Integration Capacitor

In the phase detection auto focus, it is necessary to extract the charges of the photodiodes PD1 and PD2 as pixel values independently from each other (that is, without mixing). On the other hand, as exemplified in the circuit diagram of FIG. 4, the overflow integration capacitor LOFIC is shared by the photodiodes PD1 and PD2. That is, charges may be sent to the overflow integration capacitor LOFIC from either of the photodiode PD1 and the photodiode PD2.

Because of this, in the timing chart of FIG. 9, at the point in which the charges have flowed into the overflow integration capacitor LOFIC, the pixel values acquired from the photodiodes PD1 and PD2 are eliminated without being used for the phase detection auto focus.

However, as described above, the form of accumulation of the charges differs between the photodiodes PD1 and PD2 due to the difference in the angles of incidence or the like. Therefore, there may be a case in which, for example, the charges flowing into the overflow integration capacitor LOFIC are solely from one of the photodiode PD1 and the photodiode PD2. In this case, there is no mixing of the charges from the photodiodes PD1 and PD2 at the overflow integration capacitor LOFIC. When there is no mixing of the charges, phase detection auto focus using the charges accumulated in the overflow integration capacitor LOFIC becomes possible.

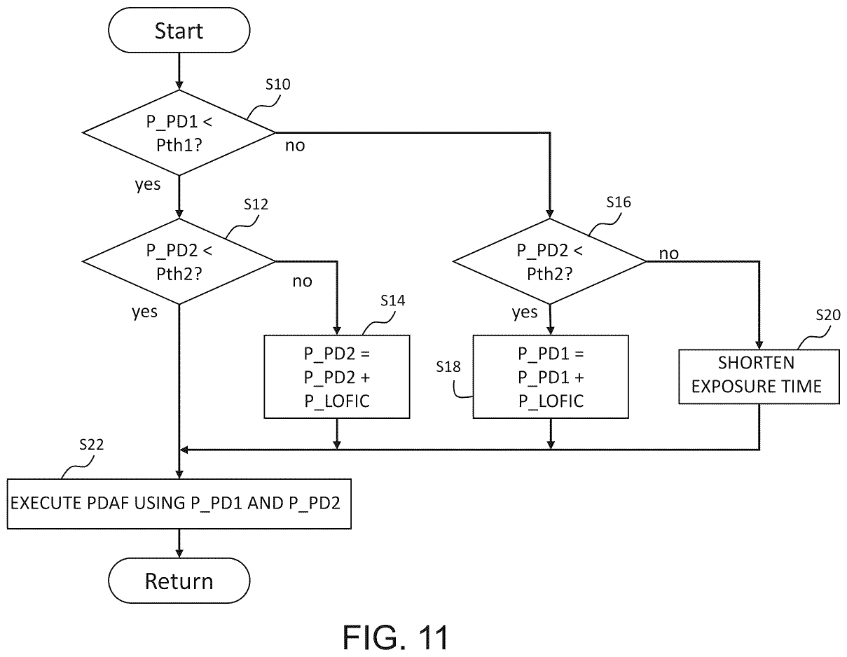

FIG. 11 exemplifies a control flow of the phase detection auto focus utilizing the charges of the overflow integration capacitor LOFIC. The pixel value determining unit 32 (refer to FIG. 1) determines whether or not a pixel value P_PD1 acquired from the photodiode PD1 is less than an upper limit threshold Pth1 (S10).

Here, the pixel value P_PD1 acquired from the photodiode PD1 is also called a pre-expansion pixel value. A pixel value read out from the floating diffusion FD when charges of the photodiode PD1 are transferred to the floating diffusion FD and the overflow capacitor gate LFG is in the OFF state (closed state) is the pre-expansion pixel value. At a timing after the charges are transferred from one of the photodiodes PD1 and PD2 to the floating diffusion FD, and before the overflow gate capacitor gate is set to the ON state, the CDS-ADC circuit 18 calculates (A/D converts) the pre-expansion pixel value.

When P_PD1<Pth1, no charge flows from the photodiode PD1 into the overflow integration capacitor LOFIC. Next, the pixel value determining unit 32 determines whether or not a pixel value P_PD2 acquired from the photodiode PD2 is less than an upper limit threshold Pth2 (S12). Here, both the upper limit threshold Pth1 and the upper limit threshold Pth2 may be equal to the maximum value of the pixel value (Pth1=Pth2=pixel value of 255).

When P_PD2<Pth2, no charge flows from the photodiodes PD1 and PD2 into the overflow integration capacitor LOFIC. Based on this, the auto focus processing unit executes calculation of the phase detection auto focus using the pixel value P_PD1 and the pixel value P_PD2 (S22).

Returning to step S10, when P_PD1≥Pth1, it means that the photodiode PD1 is saturated, and the charges of the photodiode PD1 are accumulated in the overflow integration capacitor LOFIC. Next, the pixel value determining unit 32 determines whether or not the pixel value P_PD2 acquired from the photodiode PD2 is less than the upper limit threshold Pth2 (S16).

When P_PD2≥Pth2, it means that charges flow from both the photodiodes PD1 and PD2 into the overflow integration capacitor LOFIC. In this case, the exposure time control unit 36 applies control to shorten the exposure time on the dual pixel array 12 (S20).

When P_PD2<Pth2 in step S16, it means that the charges accumulated in the overflow integration capacitor LOFIC are only the charges from the photodiode PD1. The auto focus processing unit 34 sets a value obtained by adding a pixel value P_LOFIC acquired from the overflow integration capacitor LOFIC to the pixel value P_PD1 acquired from the photodiode PD1 as a new pixel value P_PD1 (S18).

The pixel value P_LOFIC acquired from the overflow integration capacitor LOFIC refers to a pixel value which is read out from the floating diffusion FD when the overflow capacitor gate LFG is in the ON state (open state). The pixel value P_LOFIC is also called a post-expansion pixel value. That is, the CDS-ADC circuit 18 (refer to FIG. 1) calculates (A/D converts) the post-expansion pixel value when the overflow gate capacitor gate is in the ON state. For example, the new pixel value P_PD1 may assume a value greater than or equal to 255.

Further, using the new pixel value P_PD1 and the pixel value P_PD2 acquired from the photodiode PD2, the auto focus processing unit 34 executes the calculation of the phase detection auto focus (S22).

Returning to step S12, when P_PD2≥Pth2, it means that the charges accumulated in the overflow integration capacitor LOFIC are only the charges from the photodiode PD2. The auto focus processing unit 34 sets a value obtained by adding the pixel value P_LOFIC acquired from the overflow integration capacitor LOFIC to the pixel value P_PD2 acquired from the photodiode PD2 as a new pixel value P_PD2 (S14). Further, the auto focus processing unit 34 executes the calculation of the phase detection auto focus using the new pixel value P_PD2 and the pixel value P_PD1 acquired from the photodiode PD1 (S22).

FIG. 12 exemplifies a timing chart corresponding to the step S18 of FIG. 11. In correspondence to the flowchart of FIG. 11, a period of A/D conversion is determined. That is, when the charges of the photodiode PD1 are saturated (when the pixel value is the maximum value), the overflow capacitor gate LFG is set to the ON state (open). Subsequently, charges during the ON period (open period) of the overflow capacitor gate LFG are read out from the floating diffusion FD.

Similarly, when the charges of the photodiode PD2 are saturated, the overflow capacitor gate LFG is set to the ON state (open). Subsequently, the charges during the ON period of the overflow capacitor gate LFG are read out from the floating diffusion FD.

For example, with reference to times t44 to t45, from the time of setting ON (open) of the transfer gate TX1, reading out of the charges (A/D conversion) is performed with respect to the floating diffusion FD. During this period, the photodiode PD1 is set as a charge transfer target. That is, calculation of the pre-expansion pixel value is performed by the CDS-ADC circuit 18.

When the amount of charges of the floating diffusion FD (that is, the amount of charges accumulated in the photodiode) has reached the saturation charge amount Vth, at time t45, calculation of the pixel value (pre-expansion pixel value) based on the photodiode PD1 is completed.

Because the amount of charges of the floating diffusion FD has reached the saturation charge amount Vth, at time t45, the overflow capacitor gate LFG is set to the ON state (open). The potential of the floating diffusion FD is reduced by the overflow integration capacitor LOFIC. During a period of times t46 to t47, the charges in the floating diffusion FD are read out. That is, the calculation of the post-expansion pixel value is performed by the CDS-ADC circuit 18.

At times t48 to t49 and t56 to t57, the pixel value (pre-expansion pixel value) based on the photodiode PD2 is read out. In this example, the amount of charges accumulated in the photodiode PD2 which is the charge transfer target is less than the saturation charge amount. In this case, the overflow capacitor gate LFG is not opened. That is, the post-expansion pixel value is not read out.

With the timing chart described above, the pixel value of the photodiode PD1 in the saturated state (pre-expansion pixel value), the pixel value of the overflow integration capacitor LOFIC (post-expansion pixel value), and the pixel value of the photodiode PD2 in the unsaturated state (pre-expansion pixel value) are acquired. In this case, in the overflow integration capacitor LOFIC, the charges of the photodiode PD1 are solely accumulated.

The auto focus processing unit 34 sets a sum of the pixel value of the photodiode PD1 in the saturated state and the pixel value of the overflow integration capacitor LOFIC as a new pixel value of the photodiode PD1. Subsequently, the auto focus processing unit 34 executes the calculation of the phase detection auto focus based on the new pixel value of the photodiode PD1 and the pixel value acquired from the photodiode PD2.

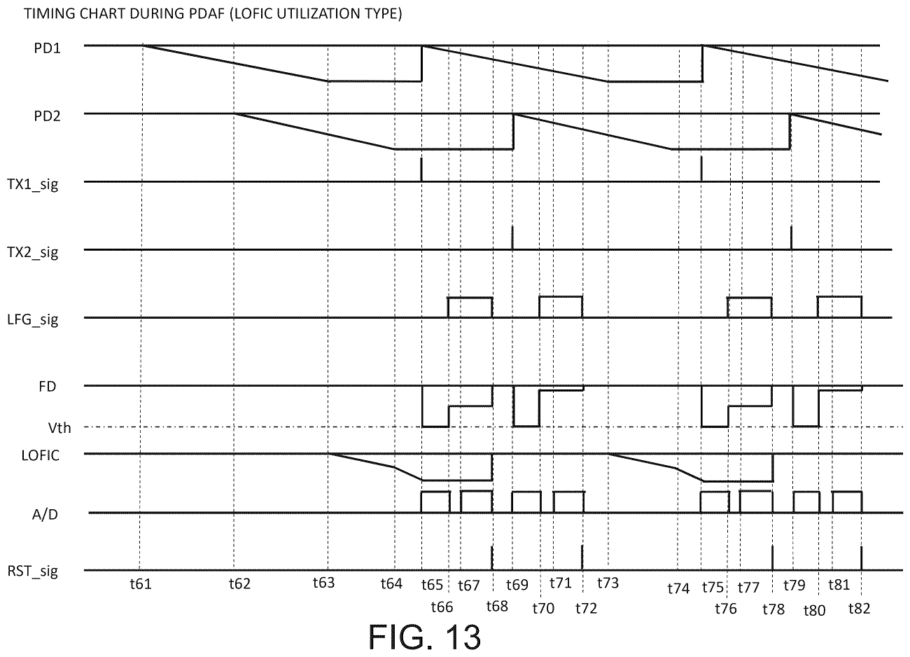

FIG. 13 shows an example where the step S20 of FIG. 11 is reached. In this example, in particular, at times t63 and t73, and times t64 and t74, both of the photodiodes PD1 and PD2 are saturated. In this case, charges from both photodiodes PD1 and PD2 flow into the overflow integration capacitor LOFIC. In this case, neither the pixel values acquired from the photodiodes PD1 and PD2 (pre-expansion pixel values) nor the pixel value acquired from the overflow integration capacitor LOFIC (post-expansion pixel value) are used for the phase detection auto focus (the pixel values are discarded). Then, as described above, the exposure time is shortened.

In this manner, in the phase detection auto focus exemplified in the flowchart of FIG. 11, in addition to the dynamic range of the image production, the dynamic range of the phase detection auto focus is also expanded. The dynamic range of the phase detection auto focus being expanded means that the maximum value of the pixel value for which the phase detection auto focus can be executed is increased.

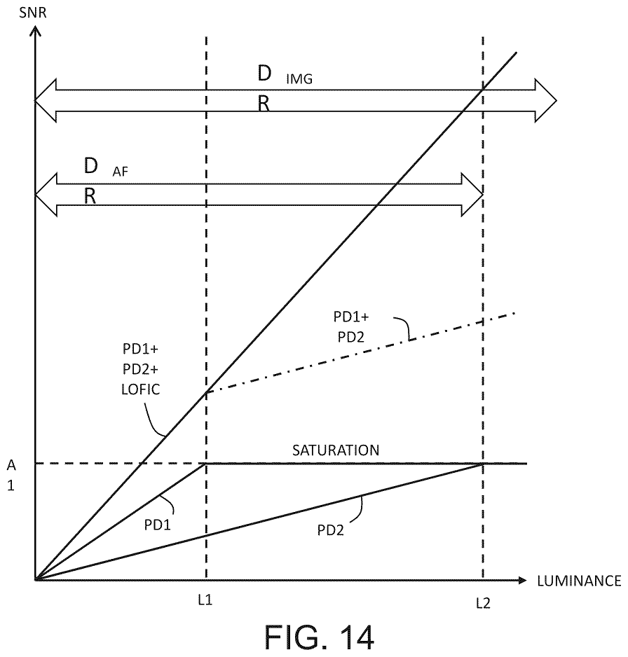

FIG. 14 exemplifies the dynamic range DR_{IMG} during the image production and the dynamic range DR_{AF} during the phase detection auto focus. The dynamic range DR_{AF} is determined based on the pixel value acquired according to the flowchart exemplified in FIG. 11. The dynamic range DR_{IMG} is identical to the dynamic range DR_{IMG} exemplified in FIG. 10.

Similar to FIG. 10, in a graph of FIG. 14, the horizontal axis shows the luminance, and the vertical axis shows the S/N ratio. As shown in this graph, the dynamic range DR_{AF} of the phase detection auto focus is further expanded from a point (L1, A1) where one of the photodiodes PD1 and PD2 is saturated. That is, the dynamic range DR_{AF} is expanded until the other photodiode PD2 is saturated.

### 7. Alternative Configuration of Present Embodiment

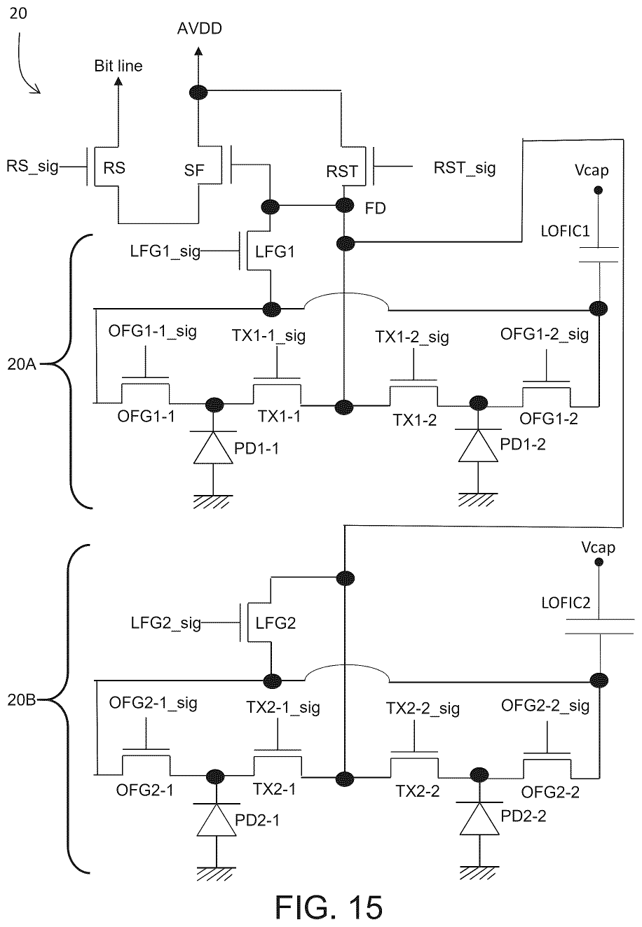

FIG. 15 shows a solid-state imaging element 20 according to an alternative configuration of the present embodiment. For example, the solid-state imaging element 20 has a so-called shared pixel structure.

The solid-state imaging element 20 comprises two pairs of dual pixel circuits 20A and 20B. That is, the solid-state imaging element 20 comprises four photodiodes PD1-1, PD1-2, PD2-1, and PD2-2. The photodiodes PD1-1, PD1-2, PD2-1, and PD2-2 share a floating diffusion FD. In addition, the photodiodes PD1-1, PD1-2, PD2-1, and PD2-2 share a logic circuit portion downstream of the floating diffusion FD. In the dual pixel circuit 20A, an overflow integration capacitor LOFIC1 is provided. In the dual pixel circuit 20B, an overflow integration capacitor LOFCI2 is provided.

For example, when a 2×2 binning process is performed, transfer gates TX 1-1, TX 1-2, TX2-1, and TX2-2 are simultaneously set to the ON state (open). In addition, overflow capacitor gates LFG1 and LFG2 are set to the ON state (open). In this case, the potential of the floating diffusion FD is determined by charges accumulated in the photodiodes PD1-1, PD1-2, PD2-1, and PD2-2, and charges accumulated in the overflow integration capacitors LOFIC1 and LOFIC2.

The present disclosure is not limited to the present embodiments described above, and includes all changes and modifications without departing from the technical scope or the essence of the present disclosure as defined by the claims.

1. A solid-state imaging element comprising:
a pair of photodiodes;
a floating diffusion that is shared by the pair of photodiodes;
a pair of transfer gates provided between respective ones of the pair of photodiodes and the floating diffusion;
an overflow integration capacitor that is shared by the pair of photodiodes; and
a pair of overflow gates provided between respective ones of the pair of photodiodes and the overflow integration capacitor, and in each of which a potential barrier is set to be lower than that of a respective one of the pair of transfer gates during a charge accumulation period of a respective one of the pair of photodiodes.

2. An imaging apparatus comprising the solid-state imaging element according to claim 1, further comprising:
a constant voltage source that applies voltages that are equal to each other to the pair of overflow gates.

3. An imaging apparatus comprising the solid-state imaging element according to claim 1, further comprising:
an A/D converter that reads out charges of the floating diffusion and converts the charges into a pixel value, wherein
the solid-state imaging element comprises an overflow capacitor gate provided between the overflow integration capacitor and the floating diffusion,
with respect to a pair of photodiodes designated as a pixel for image production, the pair of transfer gates are simultaneously set to an ON state, and transfer charges to the floating diffusion,
further, with respect to the floating diffusion to which the charges are transferred from the pair of photodiodes, the overflow capacitor gate is set to an ON state, and
the A/D converter reads out the charges of the floating diffusion during a period in which the overflow capacitor gate is in the ON state.

4. An imaging apparatus comprising the solid-state imaging element according to claim 1, further comprising:
an exposure time control unit that controls an exposure time corresponding to the charge accumulation period, wherein
for a pair of photodiodes designated as a pixel for phase detection auto focus, charges are transferred at timings different from each other to the floating diffusion, and
the exposure time control unit shortens the exposure time when at least one of the pair of photodiodes has reached a saturation charge amount.

5. An imaging apparatus comprising the solid-state imaging element according to claim 1, further comprising:
an A/D converter that reads out charges of the floating diffusion and converts the charges into a pixel value, wherein
the solid-state imaging element comprises an overflow capacitor gate provided between the overflow integration capacitor and the floating diffusion,
with respect to a pair of photodiodes designated as a pixel for phase detection auto focus, the pair of transfer gates are set to an ON state at timings different from each other, and transfer charges to the floating diffusion,
when the photodiode for which charges are transferred has reached a saturation charge amount, the overflow capacitor gate is set to an ON state with respect to the floating diffusion to which the charges are transferred from the photodiode which has reached the saturation charge amount, and
the A/D converter calculates a pre-expansion pixel value before the overflow capacitor gate is set to the ON state, and a post-expansion pixel value when the overflow capacitor gate is in the ON state.

6. The imaging apparatus according to claim 5, further comprising:
an auto focus processing unit that controls a lens position based on the phase detection auto focus, wherein
when one of the pair of photodiodes has reached the saturation charge amount and the other of the pair of photodiodes is below the saturation charge amount, the auto focus processing unit sets a sum of the pre-expansion pixel value and the post-expansion pixel value of the one of the pair of photodiodes as a pixel value of the one of the pair of photodiodes.

7. The imaging apparatus according to claim 5, further comprising:
an exposure time control unit that controls an exposure time corresponding to the charge accumulation period, wherein
when both of the pair of photodiodes have reached the saturation charge amounts, the exposure time control unit shortens the exposure time.

8. An imaging method using a solid-state imaging element comprising:
a pair of photodiodes;
a floating diffusion that is shared by the pair of photodiodes;
a pair of transfer gates provided between respective ones of the pair of photodiodes and the floating diffusion;
an overflow integration capacitor that is shared by the pair of photodiodes; and
a pair of overflow gates provided between respective ones of the pair of photodiodes and the overflow integration capacitor, wherein
a potential barrier of each of the pair of overflow gates is set to be lower than that of a respective one of the pair of transfer gates during a charge accumulation period of a respective one of the pair of photodiodes.

9. The imaging method according to claim 8, wherein
voltages that are equal to each other are applied to the pair of overflow gates.

10. The imaging method according to claim 8, wherein
the solid-state imaging element comprises an overflow capacitor gate provided between the overflow integration capacitor and the floating diffusion,
an imaging apparatus comprising the solid-state imaging element comprises an A/D converter which reads out charges of the floating diffusion and converts the charges into a pixel value,
with respect to a pair of photodiodes designated as a pixel for image production, the pair of transfer gates are simultaneously set to an ON state, and transfer charges to the floating diffusion,
further, with respect to the floating diffusion to which the charges are transferred from the pair of photodiodes, the overflow capacitor gate is set to an ON state, and
the A/D converter reads out the charges of the floating diffusion during a period in which the overflow capacitor gate is in the ON state.

11. The imaging method according to claim 8, wherein
an imaging apparatus comprising the solid-state imaging element comprises an exposure time control unit which controls an exposure time corresponding to the charge accumulation period,
charges are transferred from a pair of photodiodes designated as a pixel for phase detection auto focus at timings different from each other to the floating diffusion, and
the exposure time control unit shortens the exposure time when at least one of the pair of photodiodes has reached a saturation charge amount.

12. The imaging method according to claim 8, wherein
the solid-state imaging element comprises an overflow capacitor gate provided between the overflow integration capacitor and the floating diffusion,
an imaging apparatus comprising the solid-state imaging element comprises an A/D converter which reads out charges of the floating diffusion and converts the charges into a pixel value,
with respect to a pair of photodiodes designated as a pixel for phase detection auto focus, the pair of transfer gates are set to an ON state at timings different from each other, and transfer charges to the floating diffusion,
when the photodiode for which charges are transferred has reached a saturation charge amount, the overflow capacitor gate is set to an ON state with respect to the floating diffusion to which the charges are transferred from the photodiode which has reached the saturation charge amount, and
the A/D converter calculates a pre-expansion pixel value before the overflow capacitor gate is set to the ON state and a post-expansion pixel value when the overflow capacitor gate is in the ON state.

13. The imaging method according to claim 12, wherein
the imaging apparatus comprises an auto focus processing unit which controls a lens position based on the phase detection auto focus, and
when one of the pair of photodiodes has reached the saturation charge amount and the other of the pair of photodiodes is below the saturation charge amount, the auto focus processing unit sets a sum of the pre-expansion pixel value and the post-expansion pixel value of the one of the pair of photodiodes as a pixel value of the one of the pair of photodiodes.

14. The imaging method according to claim 12, wherein
the imaging apparatus comprises an exposure time control unit which controls an exposure time corresponding to the charge accumulation period, and
when both of the pair of photodiodes have reached the saturation charge amounts, the exposure time control unit shortens the exposure time.
